(19) United States
(12) Patent Application Publication
(10) Pub. No.: US 2016/0288995 A1
(43) Pub. Date: Oct. 6, 2016

(54) Mobile Waste & Recyclable Material Dumpster

(71) Applicant: David A. Bidelspach, Coppell, TX (US)

(72) Inventor: David A. Bidelspach, Coppell, TX (US)

(21) Appl. No.: 12/167,701

(22) Filed: Jul. 3, 2008

(51) Int. Cl. B65F 1/12; B65F 3/04; B65F 1/16

(52) U.S. Cl. CPC B65F 1/122; B65F 1/1646; B65F 3/041

(57) ABSTRACT

A mobile dumpster for storing solid waste, including recyclable materials may include a side member, a back member connected to the side member, a front member connected to the side member, a bottom member connected to the front member, back member and side member to form an interior of the mobile dumpster for storing the solid waste, including recyclable materials, a first towing arm member and a second towing arm member for connecting the mobile dumpster to a car or truck, or another type of engine powered piece of equipment to be towed and a rotatable top member to rotate to allow the refuse to enter and exit the interior of the mobile dumpster and a receiver tube member and ball mount member to allow multiple mobile dumpsters to be towed simultaneously. The mobile dumpster may include a wheel member, and the mobile dumpster may include a fender member to cooperate with the wheel member.

### FIELD OF THE INVENTION

The invention relates to a totally self-contained mobile dumpster for containing, collecting and controlling solid waste, including recyclable materials, at a solid waste and recyclable materials collection site. More particularly, the invention is a dumpster adapted for use as a mobile device to be pulled by a vehicle or an alternative engine powered piece of equipment. In addition, multiple mobile dumpsters can be towed with the use of a receiver tube and ball mount.

### BACKGROUND OF THE INVENTION

Proper collection, containment, control, transportation and disposal of solid waste, including recyclable materials are necessary for protecting public health and safety and for promoting a clean environment. Containers, commonly known as dumpsters, that hold solid waste, including recyclable materials, generated at multifamily residential, institutional, commercial, industrial, and construction sites, are an important tool in the management of solid waste, including recyclable materials.

There are at least two (2) types of dumpsters for handling solid waste, including recyclable materials, the “front loader” dumpster and the “rear loader” dumpster. Present dumpster designs incorporate several common features including: a floor, side walls, and end walls which together define an interior compartment; openings through which solid waste, including recyclable materials, is placed into the interior compartment; openings through which the solid waste, including recyclable materials, is discharged out of the interior compartment; and means for supporting the dumpster while the solid waste, including recyclable materials, is being discharged.

The front loader type dumpster is typically used at multifamily residential, commercial and industrial sites and is provided with sleeves fixed to the exterior of the side walls to receive the lifting arms of a front loading truck. The front load dumpsters typically have holding capacities of two (2), three (3), four (4), six (6) and eight (8) cubic yards. But, they are not limited to these capacities. The front loading truck approaches the front loader dumpster and positions the arms of the truck within the sleeves of the dumpster. The driver then activates a hydraulic system which lifts the dumpster over the cab of the truck and rotates it to a substantially inverted position to discharge the solid waste, including recyclable materials, into a larger compartment on the back of the truck, generally referred to as a hopper. Next, the driver lowers the empty dumpster and withdraws the lifting arms of the front loading truck from the sleeves. The driver may then activate a compactor blade in the hopper to compact the solid waste, including recyclable materials, and thereby increase the amount of solid waste, including recyclable materials, that the hopper can accommodate. The front loading truck then travels to the location of the next front loader dumpster to repeat the procedure until the hopper is full. Once the hopper is full, the front loading truck travels to a disposal or recycle site, such as a landfill or materials recovery facility, to dispose of the solid waste, or to recycle the recyclable materials.

The rear loader type dumpster is the same capacity as the front loader dumpsters, and likewise used at multifamily residential, commercial and industrial, including construction sites. Rather than being emptied into the front of the loading truck, the rear loader dumpster is pulled and raised by a hydraulically powered cable that empties the solid waste, including recyclable materials, into the rear compartment (hopper) of the rear loading truck. The materials (solid waste and recyclables) collected in a rear loading truck are managed the same as the materials collected in a front loading truck.

Utilizing different types of dumpsters, which each require a different method of discharging the solid waste, including recyclable materials, reduces both the cost effectiveness and the efficiency of collecting solid waste, including recyclable materials. Conventional front loader type dumpsters are less costly to operate, due to the fact that the driver can empty the dumpster without exiting the cab of the vehicle. Conventional rear loader type dumpsters require the driver to exit the cab of the vehicle, and typically require the need for a helper. As such, a rear loader dumpster cannot be emptied by a front loading truck. Therefore, the front loading dumpsters are more cost effective to utilize in the collection of solid waste, including recyclable materials.

A major environmental concern is the accidental dispersal of solid waste, including recyclable materials, from a front loader dumpster while the solid waste, including recyclable materials, is being discharged into the hopper of the front loading truck. For example, a sudden gust of wind may disperse some of the solid waste, including recyclable materials, onto the ground surrounding the front loading truck as the front loader dumpster is being emptied. Front loader dumpsters are emptied at collection sites that are typically located in areas where people live and work. Thus, the solid waste, including recyclable materials, that is accidentally dispersed has a negative impact on the public health and safety, as well as the local environment.

### SUMMARY

A dumpster trailer for storing solid waste, including recyclable materials, may include a side member, a back member connected to the side member, a front member connected to the side member, a bottom member connected to the front member, back member and side member to form an interior of the dumpster trailer for storing the refuse, a first hitch arm member and a second hitch arm member for connecting the dumpster trailer to a vehicle to be towed and a rotatable top member to rotate to allow the refuse to enter and exit the interior of the trailer.

The dumpster trailer may include a wheel member, and the dumpster trailer may include a fender member to cooperate with the wheel member.

The dumpster trailer may include a axle member to connect the wheel member, and the bottom member may include a depression member to cooperate with the axle member.

The rotatable top member may include a hinge member, and the dumpster trailer may include a sleeve member positioned on the side member to cooperate with an arm of a vehicle.

The dumpster trailer may include a guide member to guide the arm to the sleeve member.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a side view of the mobile dumpster of the present invention;

FIG. 2 illustrates a bottom view of the mobile dumpster of the present invention;

FIG. 3 illustrates a back view of the mobile dumpster of the present invention;

FIG. 4 illustrates another side view of the mobile dumpster of the present invention; and

FIG. 5 illustrates another side view of the mobile dumpster of the present invention.

### DETAILED DESCRIPTION

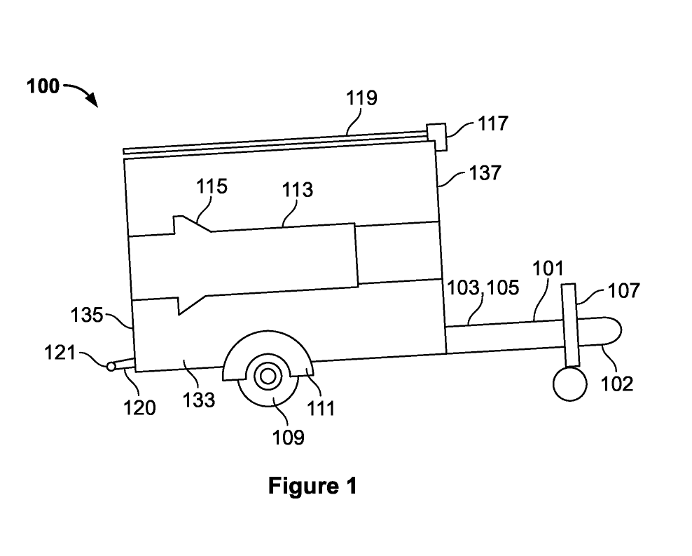

FIG. 1 illustrates a side view of the mobile dumpster 100 of the present invention. The mobile dumpster 100 provides an advantage of being able to be easily towed to a place which requires a solid waste, including recyclable materials collection site. Also, with the addition of a receiver tube and ball mount on the opposite side of the towing member of the mobile dumpster a second (2^{nd}), third (3^{rd}) or fourth (4^{th}) mobile dumpster can be towed simultaneously. Furthermore, the mobile dumpster(s) 100, once full, can be towed to a place where the mobile dumpster(s) can be emptied by a front or rear load truck.

FIG. 1 illustrates that the mobile dumpster 100 may include a towing member 101 which may extend substantially horizontally to be connected to a vehicle such as a car and truck, or another type of engine powered piece of equipment and which may be rigid and connected to the bottom of the mobile dumpster 100. The mobile dumpster 100 may include a first towing arm member 103 and may include a second towing arm member 105 which may extend substantially horizontally and extend outward and join at a coupler member 102 which may connect to a vehicle such as a car or truck, or another type of engine powered piece of equipment. FIG. 1 additionally illustrates that the mobile dumpster 100 may include a wheel and tire member 109 positioned on each side of the dumpster 100 to allow the mobile dumpster 100 to be towed to a different location. The mobile dumpster 100 may include a fender member 111 in order to help control the moisture and debris which may be thrown from the wheel and tire member 109. The mobile dumpster 100 may include a sleeve member 113 to cooperate with arms of a vehicle such as lifting arms of a front loading truck to dump the mobile dumpster 100, and the mobile dumpster 100 may include guide member 115 to guide the arms into the sleeve member 113. The sleeve member 113 and the guide member 115 may be positioned along the side member 133 which may be formed between the front member 137 and the back member 135. The side member(s) 133, the front member 137, the bottom member 141 and the back member 135 may be connected together to form an interior of the mobile dumpster 100 to store solid waste, including recyclable materials. The top of the mobile dumpster 100 includes a rotatable top member 119 which may rotate to allow the interior of the mobile dumpster 100 to be emptied. The side member 133, the front member 137, the bottom member 141 and the back member 135 may be formed from a rigid sheet to form a hollow housing for mobile dumpster 100. The mobile dumpster 100 may include a receiver tube member 120 and ball mount member 121 on the opposite side of the towing member 101 which may connect to a second (2^{nd}), third (3^{rd}) or fourth (4^{th}) mobile dumpster, to allow multiple mobile dumpsters to be towed simultaneously.

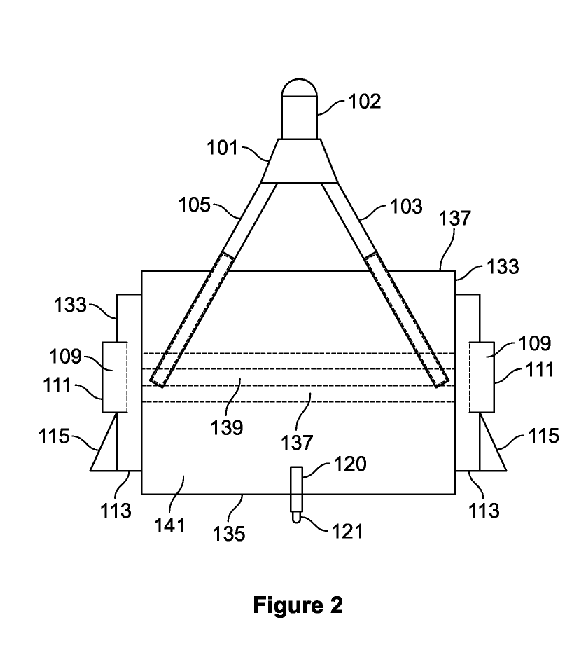

FIG. 2 illustrates a bottom view of the mobile dumpster 100 which may include a bottom member 141. The bottom member 141 may include a depressed portion 137 to cooperate with the shaft (axle) member 139 which may connect the two (2) wheel and tire members 109. FIG. 2 illustrates that the mobile dumpster 100 may include a towing member 101 which may extends substantially horizontally to be connected to a vehicle such as a car or truck, or another type of engine powered piece of equipment. The mobile dumpster 100 may include a first towing arm member 103 and may include a second towing arm member 105 which may extend substantially horizontally and extend outward and join at a vehicle coupler member 102 which may connect to a vehicle such as a car or truck, or another type of engine powered piece of equipment. FIG. 2 additionally illustrates that the mobile dumpster 100 may include a wheel and tire member 109 positioned on each side of the mobile dumpster 100 to allow the mobile dumpster 100 to be towed to a different location. The mobile dumpster 100 may include a fender member 111 in order to help control the moisture and debris which may be thrown from the wheel and tire member 109. The mobile dumpster 100 may include a sleeve member 113 to cooperate with arms of a vehicle to dump the mobile dumpster 100, and the mobile dumpster 100 may include guide member 115 to guide the arms into the sleeve member 113. The sleeve member 113 and the guide member 115 may be positioned along the side member 133 which may be formed between the front member 137 and the back member 135. The side member 133, the front member 137, the bottom member 141 and the back member 135 form an interior of the mobile dumpster 100 to store solid waste, including recyclable materials. The top of the mobile dumpster 100 includes a rotatable top member 119 which may rotate to allow the interior of the mobile dumpster 100 to be emptied. The bottom 141 of the mobile dumpster 100 includes a receiver tube member 120 and ball mount member 121 on the opposite side of the towing member 101 to connect a second (2^{nd}), third (3^{rd}) or fourth (4^{th}) mobile dumpster, to allow multiple mobile dumpsters to be towed simultaneously.

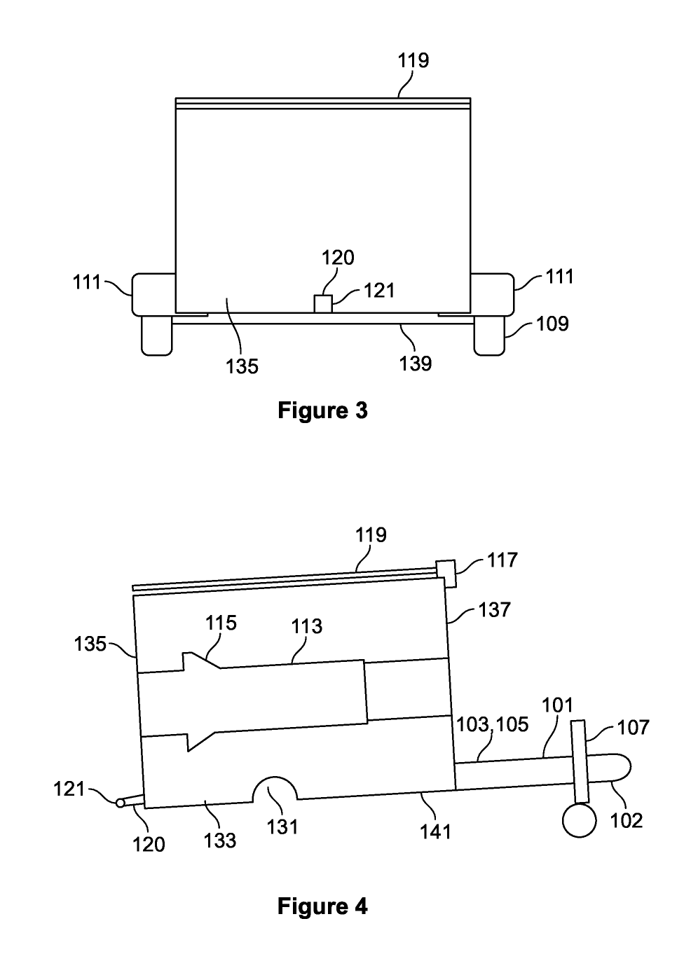

FIG. 3 illustrates a back view of the mobile dumpster 100. FIG. 3 may show the back member 135, the shaft (axle) member 139, the rotatable top member 119, the wheel and tire member 109, the fender member 111 and receiver tube member 120 and ball mount member 121.

FIG. 4 illustrates a side view of the mobile dumpster 100 without the wheel and tire member 109 and the fender member 111. The mobile dumpster 100 provides an advantage of being able to be easily towed to a location which requires a solid waste, including recyclable materials collection site. Furthermore, the mobile dumpster 100, once full, can be towed to a location where the mobile dumpster can be emptied without fear of contamination of the collection site. Additionally, the mobile dumpster 100 can be emptied at the collection site, if necessary.

FIG. 4 illustrates that the mobile dumpster 100 may include a towing member 101 which may extend substantially horizontally to be connected to a vehicle such as a car or truck, or another type of engine powered piece of equipment. The mobile dumpster 100 may include a first towing arm member 103 and may include a second towing arm member 105 which may extend substantially horizontally and extend outward and join at a vehicle coupler member 102 which may connect to a vehicle such as a car or truck, or another type of engine powered piece of equipment. The mobile dumpster 100 may include a sleeve member 113 to cooperate with arms (not shown) of a vehicle to dump the mobile dumpster 100, and the mobile dumpster 100 may include guide member 115 to guide the arms into the sleeve member 113. The sleeve member 113 and the guide member 115 may be positioned along the side member 133 which may be formed between the front member 137 and the back member 135. The side member 133, the front member 137, the bottom member 141 and the back member 135 form an interior of the mobile dumpster 100 to store solid waste, including recyclable materials. The top of the mobile dumpster 100 includes a rotatable top member 119 which may rotate to allow the interior of the mobile dumpster 100 to be emptied. The mobile dumpster may include a receiver tube member 120 and ball mount member 121.

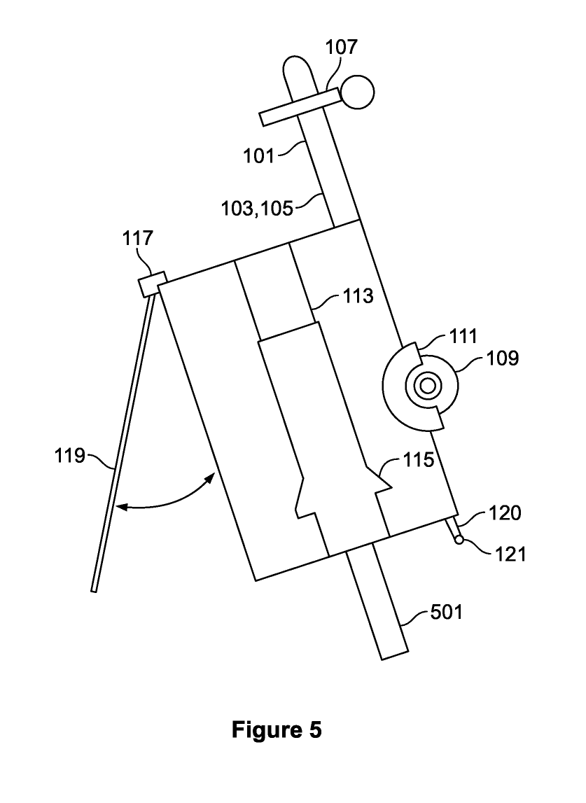

FIG. 5 illustrates that the mobile dumpster 100 is being lifted by arms 501 of a vehicle such as lifting arms of a front loading truck engaging the sleeve member 113 and that the rotatable top member 119 has opened by virtue of gravity.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A dumpster trailer for storing solid waste, including recyclable materials, comprising;
a side member;
a back member connected to the side member;
a front member connected to the side member;
a bottom member connected to the front member, back member and side member to form an interior of the dumpster trailer for storing the refuse;
a first hitch arm member and a second hitch arm member for connecting the dumpster trailer to a vehicle to be towed;
a rotatable top member to rotate to allow the refuse to enter and exit the interior of the trailer.

2. A dumpster trailer for storing solid waste, including recyclable materials, as in claim 1, wherein the dumpster trailer includes a wheel member.

3. A dumpster trailer for storing solid waste, including recyclable materials, as in claim 2, wherein the dumpster trailer includes a fender member to cooperate with the wheel member.

4. A dumpster trailer for storing solid waste, including recyclable materials, as in claim 2, wherein the dumpster trailer includes a axle member to connect the wheel member.

5. A dumpster trailer for storing solid waste, including recyclable materials, as in claim 4, wherein the bottom member includes a depression member to cooperate with the axle member.

6. A dumpster trailer for storing solid waste, including recyclable materials, as in claim 1, wherein the rotatable top member includes a hinge member.

7. A dumpster trailer for storing solid waste, including recyclable materials, as in claim 1, wherein the dumpster trailer includes a sleeve member positioned on the side member to cooperate with an arm of a vehicle.

8. A dumpster trailer for storing solid waste, including recyclable materials, as in claim 7, wherein the dumpster trailer includes a guide member to guide the arm to the sleeve member.
